(19) United States
(12) Patent Application Publication
(10) Pub. No.: US 2009/0187452 A1
(43) Pub. Date: Jul. 23, 2009

(54) Cleaning work estimating system, cleaning work estimating method, and cleaning work estimating program

(76) Inventor: Naruto Takaoku, Shiga (JP)

Correspondence Address: MILDE & HOFFBERG, LLP, 10 BANK STREET, SUITE 460, WHITE PLAINS, NY, 10606, US

(21) Appl. No.: 11/666,213

(22) PCT Filed: Oct. 14, 2005
(86) PCT No.: PCT/JP2005/018933

§ 371 Date: Apr. 25, 2007

(30) Foreign Application Priority Data
Oct. 27, 2004 (JP) 2004-311675

(51) Int. Cl. G06Q 10/00; G06N 5/02

(52) U.S. Cl. 705/9; 706/46; 707/104.1

(57) ABSTRACT

There is provided a cleaning work estimating system 10 composed of a PC 12, wherein the PC 12 comprises: area type storing means 18 for storing the area type; surface area storing means 20 for storing the surface area; degree of contamination storing means 22 for storing the degree of contamination; degree of cleaning finish storing means 24 for storing the degree of cleaning finish; work procedure selecting means 26 for sequentially selecting work procedure; module sheet creating means 28 for creating a module sheet by allocating the sequentially selected work procedure to a module sheet in a time line fashion; shift table creating means 30 for creating a shift table; floor plan inputting means 32 for storing the floor plan; sectioning means 34 for sectioning the floor plan; and work cost estimating means 36 for estimating work costs.

### BACKGROUND OF THE INVENTION

The present invention relates to a cleaning work estimating system, a cleaning work estimating method, and a cleaning work estimating program using a personal computer (PC) or a server or the like.

Cleaning work of buildings and facilities has always been done by cleaners. There have been no objective criteria for determining work procedure or work cost estimation when carrying out this cleaning work because of being affected by the subjectivity of the client and the cleaners. Thus, cleaning work support systems for estimating cleaning work have been invented (For instance, Japanese Patent Publication No. JP2000-22467A). Although these systems were able to output a cleaning workload, the systems were unable to determine the contents of the cleaning work.

### SUMMARY OF THE INVENTION

It is an object of the present invention to provide a cleaning work estimating system, a cleaning work estimating method, and a cleaning work estimating program capable of automatically determining and outputting a cleaning work procedure according to the surface area to be cleaned or the like.

In a first preferred embodiment, there is provided a cleaning work estimating system for creating a work program for cleaning work using a computer according to the present invention which is composed of the computer, wherein the computer comprises: area type storing means for storing the area type for each area of a floor plan inputted; surface area storing means for storing the surface area for each area; degree of contamination storing means for storing the degree of contamination for each area; degree of cleaning finish storing means for storing the degree of cleaning finish for each area; work procedure selecting means for sequentially selecting work procedure for each area according to the area type, the surface area, the degree of contamination, and the degree of cleaning finish; and module sheet creating means for creating a module sheet by allocating the sequentially selected work procedure to a module sheet for each regular time interval in a time line fashion. Further, these means are composed of hardware resources, such as a CPU of a computer or a memory or the like and a program in the storing means, such as a memory or the like. Such means automatically performs the aforementioned each processing.

In a second preferred embodiment, the computer in the cleaning work estimating system of the present invention comprises shift table creating means by sorting each work procedure included in each module sheet by regular time interval and worker in the computer. Further, the work program describes cleaning work in a time line fashion and is an idea including the aforementioned module sheet and the shift table.

In a third preferred embodiment, the computer in the cleaning work estimating system of the present invention comprises work cost estimating means for estimating work costs according to the work procedure included in each of the module sheets in the computer.

In a fourth preferred embodiment, the computer in the cleaning work estimating system of the present invention comprises: floor plan inputting means for storing the floor plan inputted; and sectioning means for sectioning the floor plan for each area to store the area type for each area in the area type storing means, store the surface area for each area in the surface area storing means, and store the degree of contamination for each area in the degree of contamination storing means.

In a fifth preferred embodiment, the cleaning work estimating system of the present invention comprises estimate evaluating means for evaluating an estimate for cleaning work, wherein the estimate evaluating means comprises: evaluation standards storing means for storing quality control checking evaluation standards; check sheet storing means for storing a quality control check sheet; and evaluation entering means for entering evaluation in the check sheet based on the quality control checking standards.

In a sixth preferred embodiment, the estimate evaluating means in the cleaning work estimating system of the present invention comprises evaluation standards rewriting means for rewriting evaluation items and the quality control checking evaluation standards.

In a seventh preferred embodiment, the evaluation entering means in the cleaning work estimating system of the present invention enters evaluation in the check sheet based on the rewritten quality control checking evaluation standards.

In an eighth preferred embodiment, the estimate evaluating means in the cleaning work estimating system of the present invention further comprises procedure rewriting means for rewriting the contents of the work procedure allocated to the module sheet.

In a ninth preferred embodiment, the cleaning work estimating system of the present invention comprises the estimate evaluating means for estimating an estimate for cleaning work, wherein the estimate evaluating means comprises: the evaluation standards storing means for storing the quality control checking evaluation standards; the check sheet storing means for storing the quality control check sheet; the evaluation entering means for entering evaluation in the check sheet based on the quality control checking evaluation standards; and the shift table re-creating means for re-creating the shift table created.

In one preferred embodiment, a cleaning work estimating method of the present invention is a method for creating a work program for cleaning work using a computer, wherein the area type storing means in the computer comprises the step of storing the area type for each area of the floor plan inputted, wherein the surface area storing means in the computer comprises the step of storing the surface area for each area, wherein the degree of contamination storing means in the computer comprises the step of storing the degree of contamination for each area, wherein the degree of cleaning finish storing means in the computer comprises the step of storing the degree of cleaning finish for each area, wherein the work procedure selecting means in the computer comprises the step of sequentially selecting the work procedure for each area according to the area type, the surface area, the degree of contamination and the degree of cleaning finish, and wherein the module sheet creating means in the computer comprises the step of allocating the work procedure sequentially selected to the module sheet for each regular time interval in a time line fashion.

In another preferred embodiment of the cleaning work estimating method of the present invention, the shift table creating means in the computer comprises the step of creating a shift table by sorting each work procedure included in each of the module sheets by regular time interval and worker.

In still another preferred embodiment of the cleaning work estimating method of the present invention, the evaluation standards storing means comprises the step of storing the quality control checking evaluation standards, the check sheet storing means comprises the step of storing the quality control check sheet, and the evaluation entering means comprises the step of entering the evaluation in the check sheet based on the quality control checking evaluation standards.

In one preferred embodiment, a cleaning work estimating program of the present invention creates a work program for cleaning work using a computer, wherein the computer functions as the area type storing means for storing the area type for each area of the floor plan inputted, the surface area storing means for storing the surface area for each area, the degree of contamination storing means for storing the degree of contamination for each area, the degree of cleaning finish storing means for storing the degree of cleaning finish for each area, the work procedure selecting means for sequentially selecting the work procedure for each area according to the area type, the surface area, the degree of contamination and the degree of cleaning finish, and the module sheet creating means for allocating the work procedure sequentially selected to the module sheet for each regular time interval in a time line fashion.

In another preferred embodiment of the cleaning work estimating program of the present invention, the computer functions as the shift table creating means for creating a shift table by sorting each work procedure included in each of the module sheets by regular time interval and worker.

In still another preferred embodiment of the cleaning work estimating program of the present invention, the computer functions as the evaluation standards storing means for storing the quality control checking evaluation standards, the check sheet storing means for storing the quality control check sheet, and the evaluation entering means for entering evaluation in the check sheet based on the quality control checking evaluation standards.

Firstly, according to the cleaning work estimating system, the cleaning work estimating method, and the cleaning work estimating program of the present invention, a module sheet for each regular time interval can be created by sequentially selecting the work procedure for each area according to the area type, surface area, degree of contamination, and degree of cleaning finish. A plurality of module sheets are created in accordance with a time line in work procedures. Cleaning work procedures for each regular time interval are described concretely in each module sheet. A series of cleaning work procedures are covered by a plurality of module sheets. Thus, a series of cleaning work procedures are automatically determined to be outputted when outputting such plurality of module sheets. Further, an overall work program from the start to the end of the cleaning work can be easily estimated by sorting these module sheets. It is the essential idea of the present invention to estimate a work program for the cleaning work in units of module sheets, and the present invention has embodied this idea using a computer.

Secondly, according to the cleaning work estimating system having shift table creating means, the cleaning work estimating method, and the cleaning work estimating program of the present invention, an overall work program from the start to the end of the cleaning work can be easily managed by creating a shift table in which a work procedure is described at regular time intervals and for each worker. In addition, the use of this shift table makes it possible to give the workers instructions and education in a quick and efficient manner.

Thirdly, according to the cleaning work estimating system having work cost estimating means of the present invention, estimating work, such as labor costs or the like, can be easily and quickly carried out to show the client that outsources the cleaning work. Thus, the client and the cleaning staff can objectively grasp work costs.

Fourthly, the cleaning work estimating system having floor plan inputting means and sectioning means can create a work program and carry out work to reach an estimate for the work costs easily and quickly, resulting in more effective utilization of the present invention.

Finally, according to the cleaning work estimating system having estimate evaluating means, the cleaning work estimating method, and the cleaning work estimating program of the present invention, the client can evaluate the amount estimated or the like. In other words, the client can consider the adequacy of the estimate by looking at a check sheet in which evaluation is entered based on quality control checking evaluation standards. In addition to displaying quality standards of the cleaning work, it is possible to find whether the calculated sum or the existing contract sum has any problems with specifications, quality, work program (overall work program), and education program relating to work modules (productivity, the level of proficiency, and morals). Moreover, it is easy to change the work program caused by changes, addition, and deletion in the work modules, so that it becomes easy to change the contract sum.

For a full understanding of the present invention, reference should be made to the following detailed description of the preferred embodiments of the invention as illustrated in the accompanying drawings.

### BRIEF DESCRIPTION OF THE DRAWINGS

FIG. 1 is a block diagram of a cleaning work estimating system according to the present invention.

FIG. 2 is a block diagram showing one example of a work procedure selecting means in the cleaning work estimating system shown in FIG. 1.

FIG. 3 is screen data showing one example of a module sheet created by the cleaning work estimating system shown in FIG. 1.

FIG. 4 is screen data showing one example of a shift table created by the cleaning work estimating system shown in FIG. 1.

FIG. 5 is screen data showing a floor plan sectioned by the cleaning work estimating system shown in FIG. 1.

FIG. 6 shows one example of a database for each area to be used for the cleaning work estimating system shown in FIG. 1.

FIG. 7 is a view in which the module sheet created by the cleaning work estimating system shown in FIG. 1 is arranged in a time line fashion.

FIG. 8 shows one example of a module sheet format to be used for the cleaning work estimating system shown in FIG. 1.

FIG. 9 shows one example of a database by module to be used for the cleaning work estimating system shown in FIG. 1.

FIG. 10 shows one example of a shift table format to be used for the cleaning work estimating system shown in FIG. 1.

FIG. 11 is screen data for showing one example of a shift table created by the cleaning work estimating system shown in FIG. 1.

FIG. 12 is screen data showing one example of another shift table created by the cleaning work estimating system shown in FIG. 1.

FIG. 13 is a block diagram showing another embodiment of the cleaning work estimating system according to the present invention.

FIG. 14 is a block diagram of estimate evaluating means included in the cleaning work estimating system shown in FIG. 13.

FIG. 15 shows one example of quality control checking evaluation standards used for the cleaning work estimating system shown in FIG. 13.

FIG. 16 shows one example of quality control checking evaluation standards used for the cleaning work estimating system shown in FIG. 13.

FIG. 17 shows a status in which a score is given in the quality control checking sheet of FIG. 16.

FIG. 18 is a lay-out for showing shine measurement points when measuring the shine to give a score in the quality control check sheet in the cleaning work estimating system shown in FIG. 13.

FIG. 19 is a graph showing shine measurement results when measuring the shine to give a score in the quality control check sheet in the cleaning work estimating system shown in FIG. 13.

FIG. 20 is an inter-network block diagram for showing further another embodiment of the cleaning work estimating system according to the present invention.

### DESCRIPTION OF THE PREFERRED EMBODIMENTS

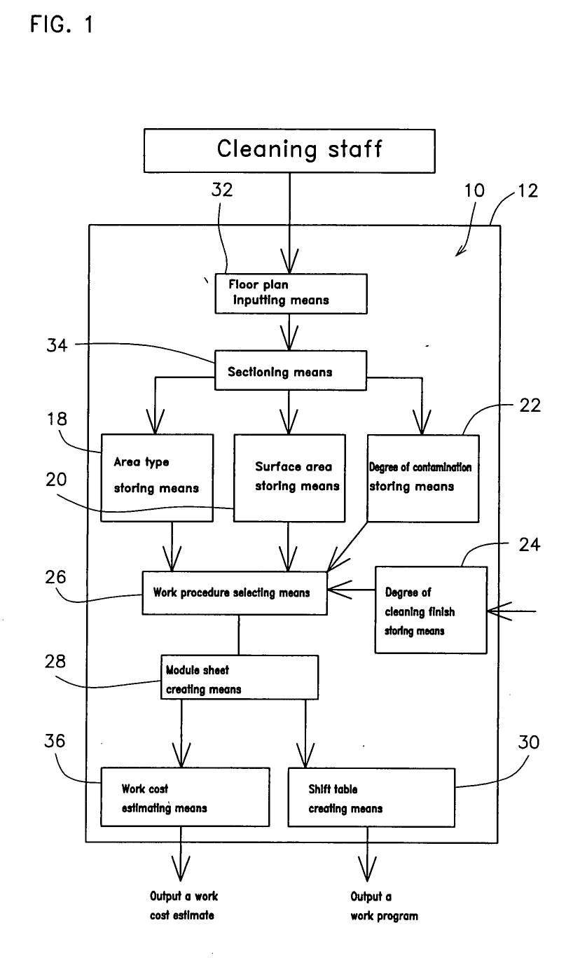

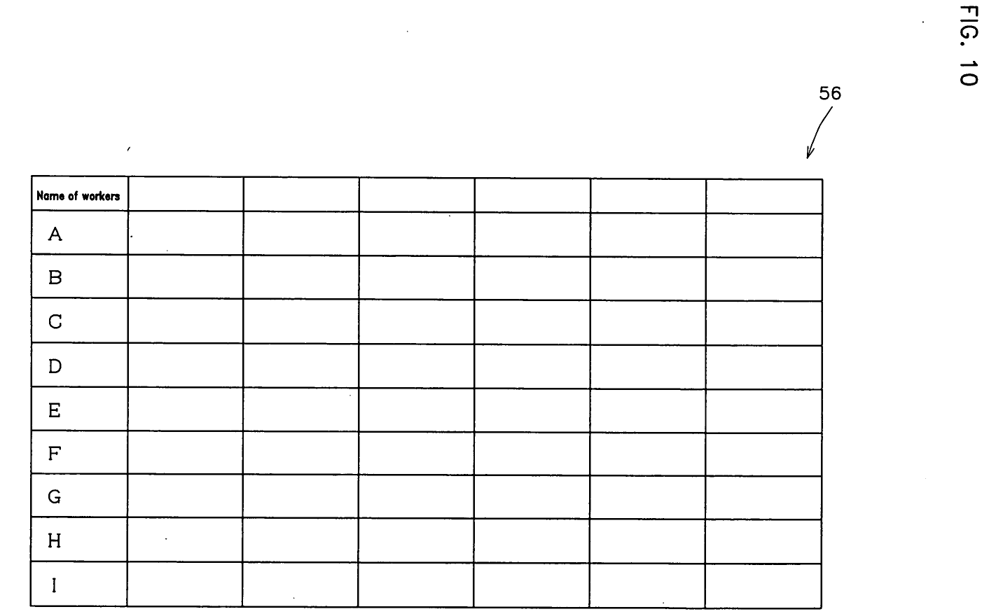

The preferred embodiments of the present invention will now be described with reference to FIGS. 1 to 20 of the drawings. Identical elements in the various figures are designated with the same reference numerals.

Embodiments of a cleaning work estimating system, a cleaning work estimating method, and a cleaning work estimating program according to the present invention will now be described in detail on the basis of the accompanying drawings. In FIG. 1, symbol 10 is a cleaning work estimating system according to the present invention.

A cleaning work estimating system 10 of the present invention is a system for creating a work program for cleaning work using a personal computer (PC) 12. The cleaning work estimating system 10 is composed of the PC 12, wherein the PC 12 comprises: area type storing means 18 for storing the area type for each area of a floor plan of a building or the like inputted in the PC 12; surface area storing means 20 for storing the surface area for each area; degree of contamination storing means 22 for storing the degree of contamination for each area; degree of cleaning finish storing means 24 for storing the degree of cleaning finish for each area; work procedure selecting means 26 for sequentially selecting work procedure for each area according to the area type, the surface area, the degree of contamination, and the degree of cleaning finish; and module sheet creating means 28 for creating a module sheet by allocating the sequentially selected work procedure to a module sheet for each regular time interval in a time line fashion; shift table creating means 30 for creating a shift table by sorting each work procedure included in each module sheet by regular time interval and worker; floor plan inputting means 32 for storing the floor plan inputted; sectioning means 34 for sectioning the floor plan for each area to store the area type for each area in the area type storing means 18, store the surface area for each area in the surface area storing means 20, and store the degree of contamination for each area in the degree of contamination storing means 22; and work cost estimating means 36 for estimating work costs according to the work procedure included in each module sheet.

Accordingly, in the cleaning work estimating program of the present invention, the PC 12 functions as the area type storing means 18, the surface area storing means 20, the degree of contamination storing means 22, the degree of cleaning finish storing means 24, the work procedure selecting means 26, the module sheet creating means 28, and the shift table creating means 30.

The floor plan inputting means 32 is configured so as to obtain from the client a floor plan of the building or the like to be cleaned to be stored by inputting with a scanner or the like. The area type storing means 18 is configured so as to store the area type, such as sales floors, passages, and rest rooms or the like for each area sectioned by the sectioning means 34. The surface area storing means 20 is configured so as to store the surface area for each area sectioned by the sectioning means 34. The degree of contamination storing means 22 is configured so as to store the degree of contamination, such as serious contamination, moderate contamination, minor contamination for each area sectioned by the sectioning means 34. The degree of cleaning finish storing means 24 is configured so as to store values of shine degree of the floor or the like (Reflectivity (%)) for each area sectioned by the sectioning means 34.

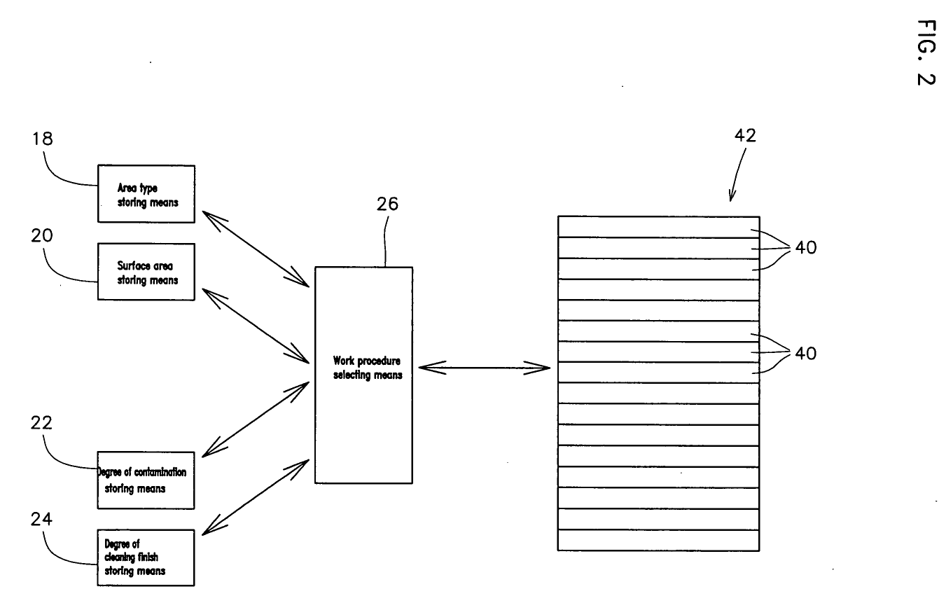

The work procedure selecting means 26 selects a work procedure to be determined according to the area type stored in the area type storing means 18, the surface area stored in the surface area storing means 20, the degree of contamination stored in the degree of contamination storing means 22, and the degree of cleaning finish stored in the degree of cleaning finish storing means 24 for each area. For instance, as shown in FIG. 2, the work procedure selecting means 26 is selected from a work procedure pattern database 42 in which a plurality of work procedure patterns 40 are systematically arranged. Examples of the work procedure patterns 40 are “Sanitization/replenishing of supplies/collection of garbage or the like/dust removal of floor surfaces/sanitizing of toilets/mirrors/wash-basins/jet towels/equipment/mopping floor/wall surfaces or the like/drain gratings” when the area type is a rest room and “Sanitization/collection of garbage or the like/dust removal of floor surfaces/mirrors/equipment/mopping floor/wall surfaces or the like” when the area type is a powder room.

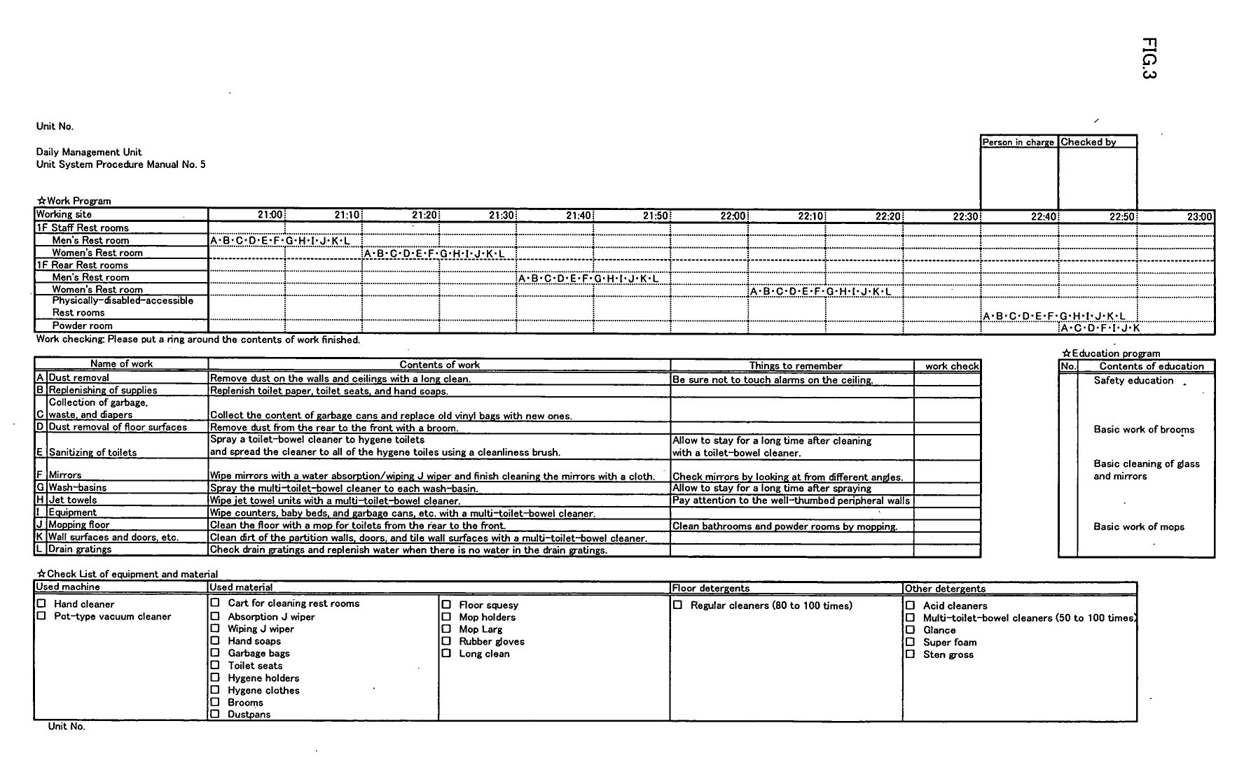

While the module sheet creating means 28 can create a series of overall work procedure programs on overall work by arranging a work procedure for each area selected from the work procedure selecting means 26 in a time line fashion, the module sheet creating means 28 is means for sectioning the overall work procedure programs at regular time intervals to obtain a plurality of module sheets. One example of a module sheet is shown in FIG. 3. The module sheet shown in FIG. 3 is sectioned every 2 hours as a regular time interval to obtain one module sheet. Equipment and materials, such as cleaners, carts, and wipers or the like used for cleaning work are also shown in this module sheet.

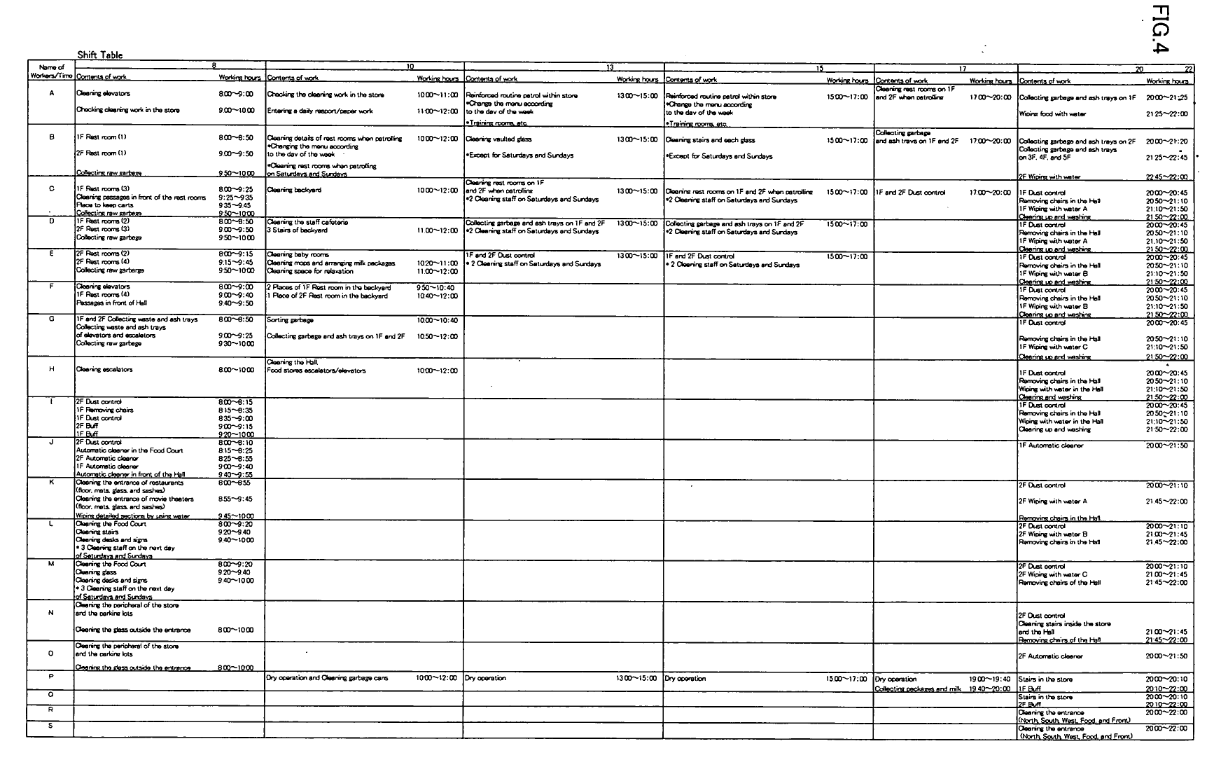

The shift table creating means 30 creates a shift table by sorting work procedures shown in each of the module sheets created as above into units of module sheets to be aligned on a shift table format. For instance, the shift table format is configured by aligning time axis in the horizontal axis and the names of a plural number of workers in the vertical axis. One example of the shift table is shown in FIG. 4. Work procedures are sorted into 2 hour increments and into workers A through S in the shift table.

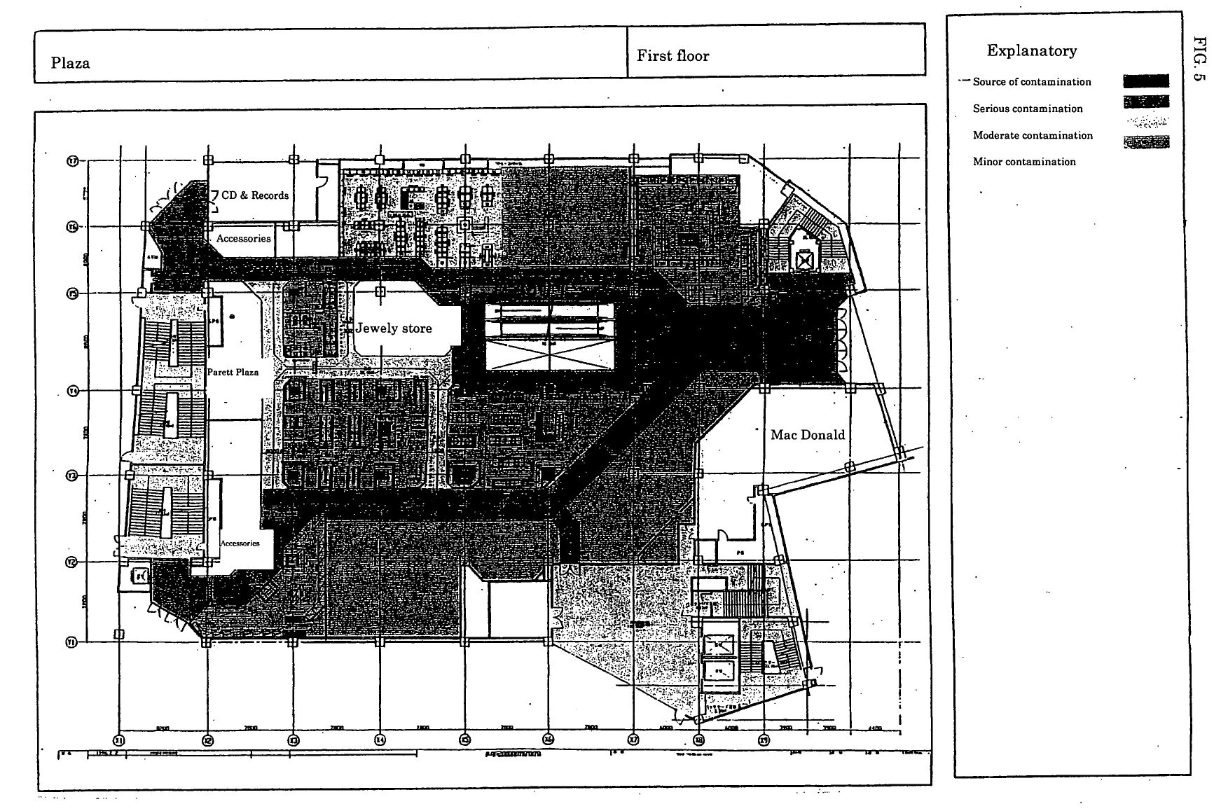

The floor plan inputting means 32 is configured so as to scan a floor plan with an image scanner or the like and store the floor plan. The sectioning means 34 is configured so as to section the floor plan scanned and store the area type and the surface area or the like for each area. An example of the sectioned floor plan is shown in FIG. 5. The work cost estimating means 36 is configured so as to calculate work costs including equipment and material costs as well as the work procedure and the surface area.

Next, the cleaning work estimating method will now be described by explaining such cleaning work estimating system 10 and the actuation of the cleaning work estimating program.

Cleaning staff who intend to utilize this cleaning work estimating system 10 firstly receive a floor plan, such as a floor plan of the building from a client who has outsourced cleaning work. This floor plan is scanned by the floor plan inputting means 32 in the PC 12 to be stored.

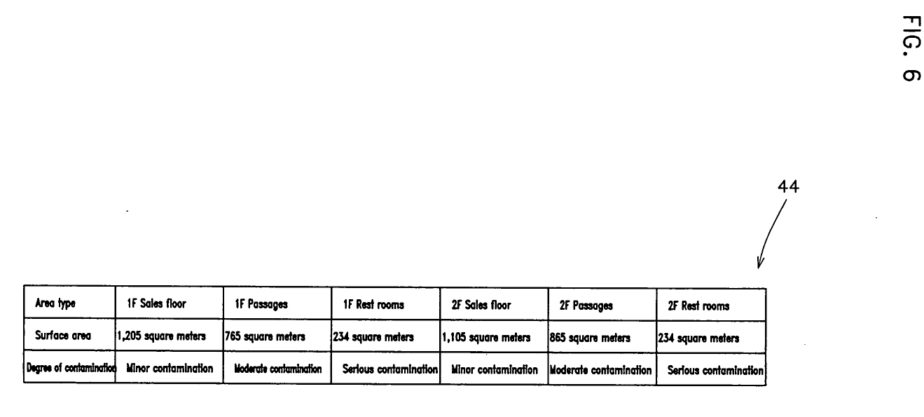

The sectioning means 34 sections the floor plan and separates by color for each area. The area type is stored in the area type storing means 18 for each area by the staff's selection. The surface area is automatically calculated for each area to be stored in the surface area storing means 20. The degree of contamination is automatically determined by the staff's selection or according to the area type to be stored in the degree of contamination storing means 22. Further, the degree of cleaning finish required by the client as specifications is inputted to be stored in the degree of cleaning finish storing means 24. A database 44 by area systematically configured for each area type as shown in FIG. 6 is formed by the storing of such data.

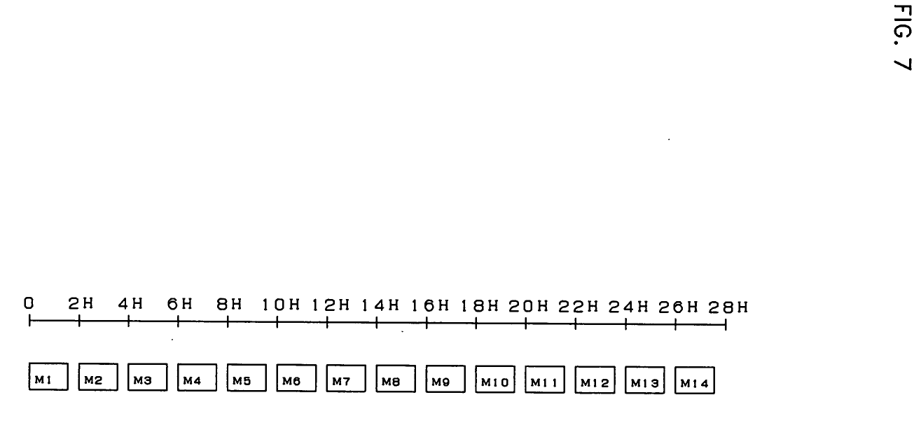

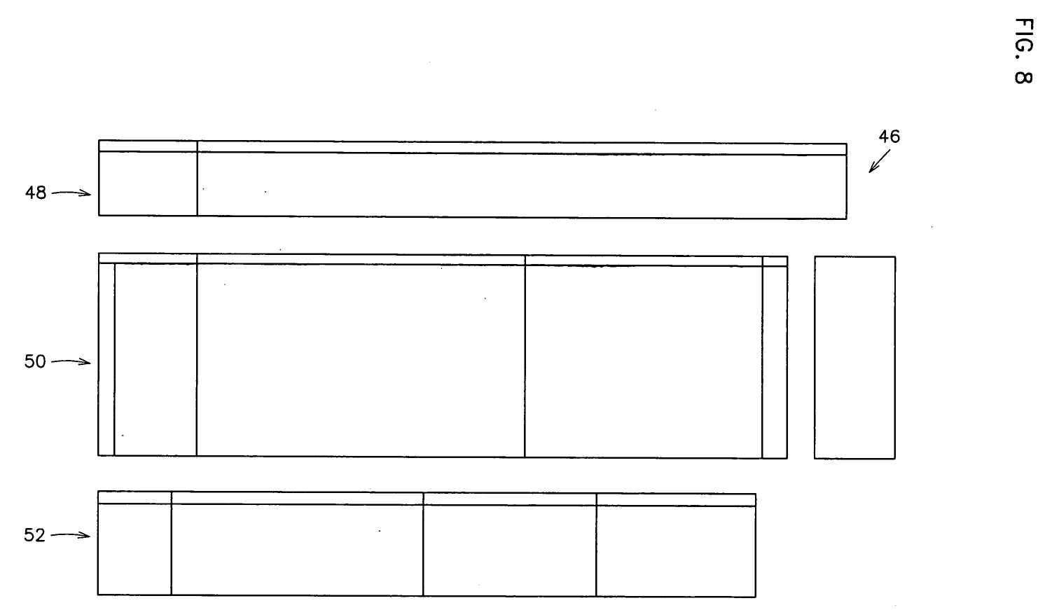

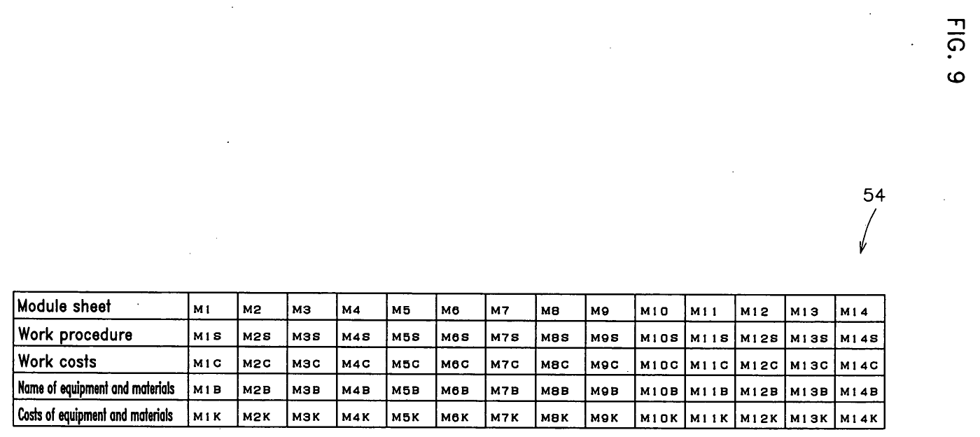

Upon forming of the database 44 by area, the work procedure selecting means 26 selects the work procedure patterns 40 from the work procedure pattern database 42 shown in FIG. 2 for each area type with reference to a series of overall work procedures in series. Secondly, the module sheet creating means 28 aligns the work procedures for each area type in a time line fashion to create a plurality of module sheets by sectioning every 2 hours. For instance, as shown in FIG. 7, 14 module sheets M1 through M14 are obtained when it has taken 28 hours man-hours to do a series of overall work by one worker. The module sheet creating means 28 calculates work costs for each module. The work costs are usually hourly rate (Yen/H)×2H. The names of equipment and materials are automatically determined by inputting based on the names of the equipment and materials for each module sheet. The equipment and material costs are automatically determined or are determined by imputing based on the names of the equipment and materials. Such data is described, for instance, on a module sheet format 46 shown in FIG. 8 for every 2 hours, so that a plurality of module sheets are created to be stored. The module sheet format 46 comprises a work procedure column 48, a work procedure description column 50, and a necessary equipment and material column 52. As a result, for instance, a database 54 by module shown in FIG. 9 is formed.

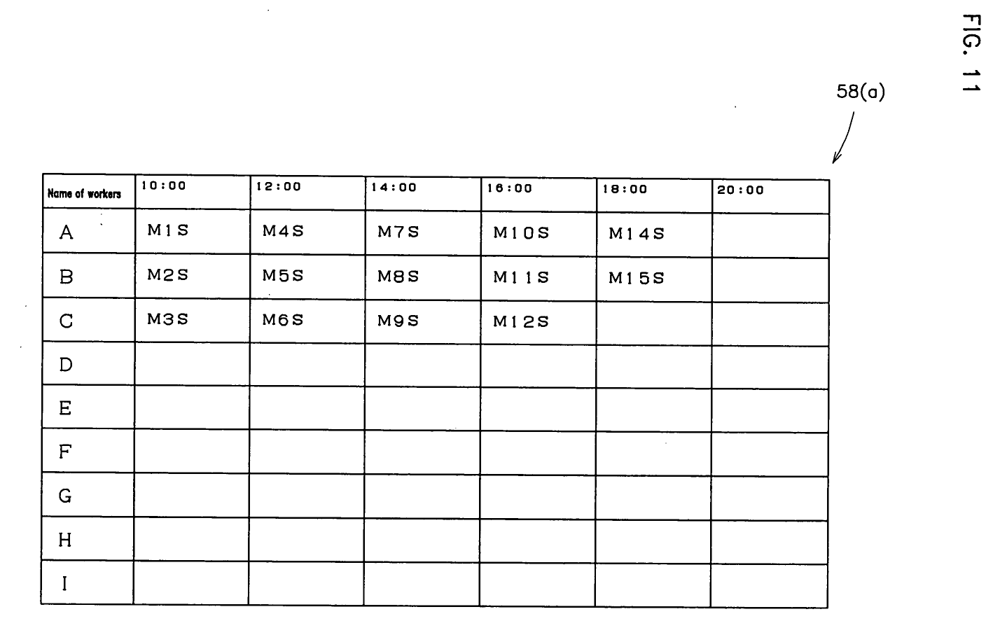

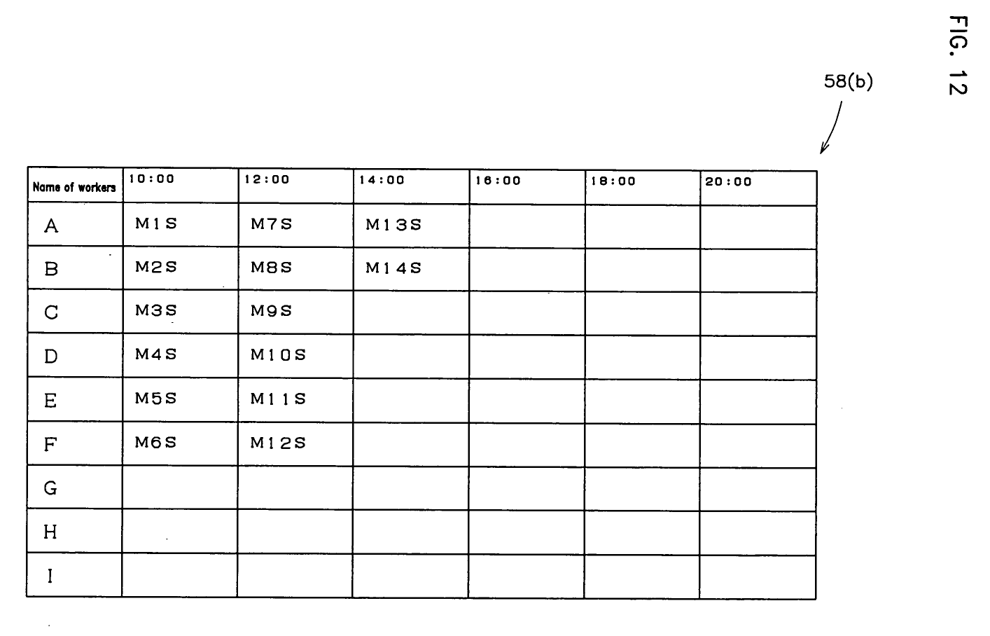

The shift table creating means 30 creates a shift table based on the database 54 by module. For one thing, a shift table is created by sorting work procedures M1S through M14S into the shift table format 56 sectioned for every 2 hours and worker as shown in FIG. 9. For instance, FIG. 11 shows a shift table 58(a) in the case of 3 workers A through C working from 10:00 to 20:00. FIG. 12 shows a shift table 58(b) in the case of 6 workers A through F working from 10:00 to 16:00. M1S through M14 are automatically allocated to A through F in order for each time interval by designating hours worked and the number of workers. More specifically, M1S is allocated to the worker A column of “10:00,” and M2S is allocated to the worker B column of “10:00,” and then up to M14S are allocated in order. Alternatively, allocations are given according to the staff's instructions. The work procedures M1S through M14S may be nonidentical to the work procedures described in each module sheet and may be partly compiled or partly omitted.

The work cost estimating means 36 estimates work costs based on the database 54 by module. Labor costs can be calculated by summing up the work costs M1C through M14C of the module sheets M1 through M14 and the total equipment and material costs can be calculated by summing up the equipment and material costs M1K through M14K.

According to such cleaning work estimating system, cleaning work estimating method, and cleaning work estimating program of the present invention, a shift table showing a series of work procedures and a work cost estimate can be created based on the module sheets by previously creating the module sheets. Accordingly, a shift table and a work cost estimate can be easily and surely created in units of module sheets. Further, software development is easy, so that the cost reduction can be made.

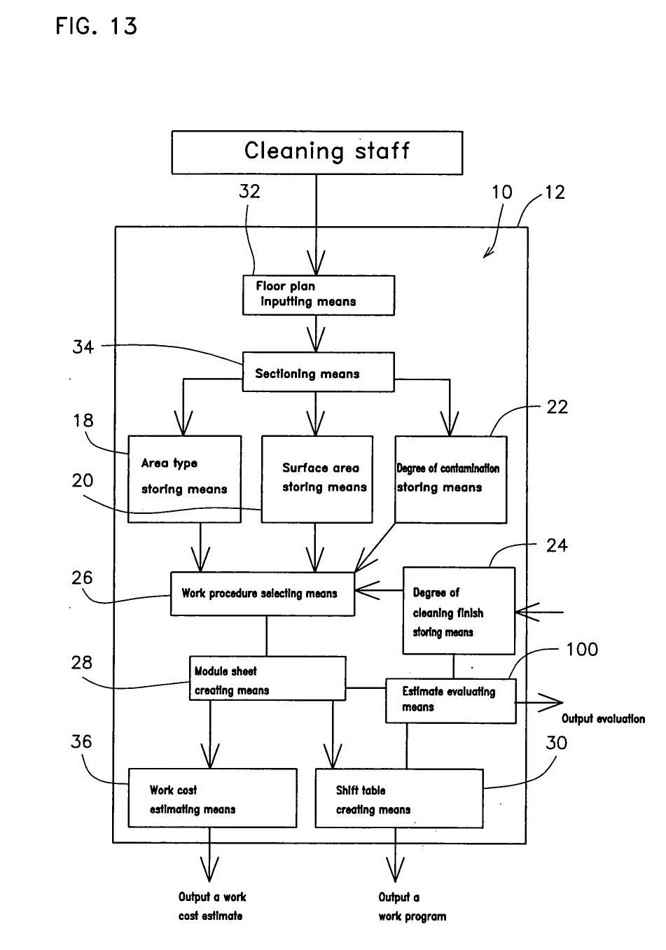

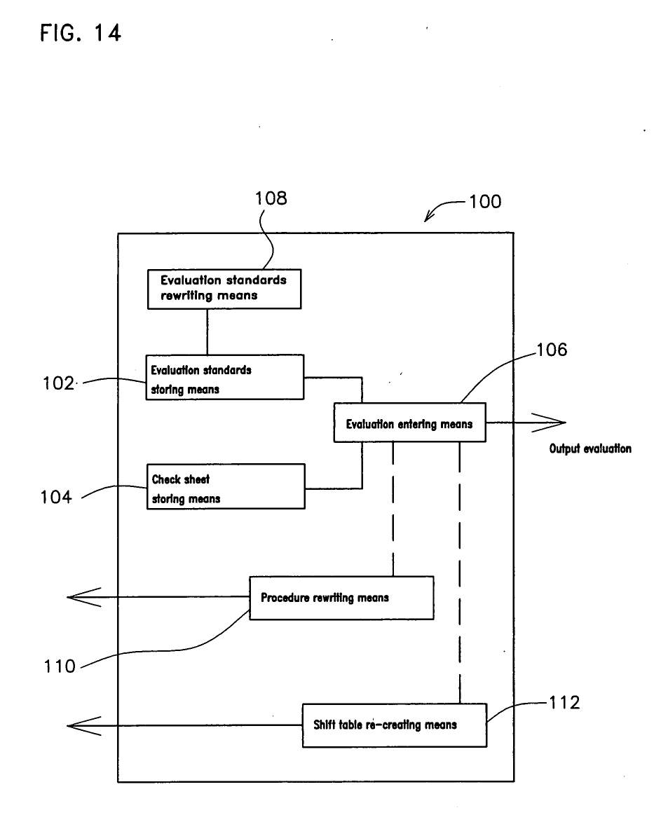

While one embodiment of the present invention has thus been described, it is to be understood that the invention is not limited to the aforementioned embodiment. For example, the cleaning work estimating system 10 may have estimate evaluating means 100 as shown in FIGS. 13 and 14.

As shown in FIG. 14, the estimate evaluating means 100 comprises: evaluation standards storing means 102 for storing quality control checking evaluation standards; check sheet storing means 104 for storing a quality control check sheet; evaluation entering means 106 for entering evaluation in the check sheet based on the quality control checking evaluation standards; evaluation standards rewriting means 108 for rewriting the quality control checking evaluation standards; procedure rewriting means 110 for rewriting the contents of the work procedures allocated to the module sheets; and shift table re-creating means 112 for re-creating the shift table created.

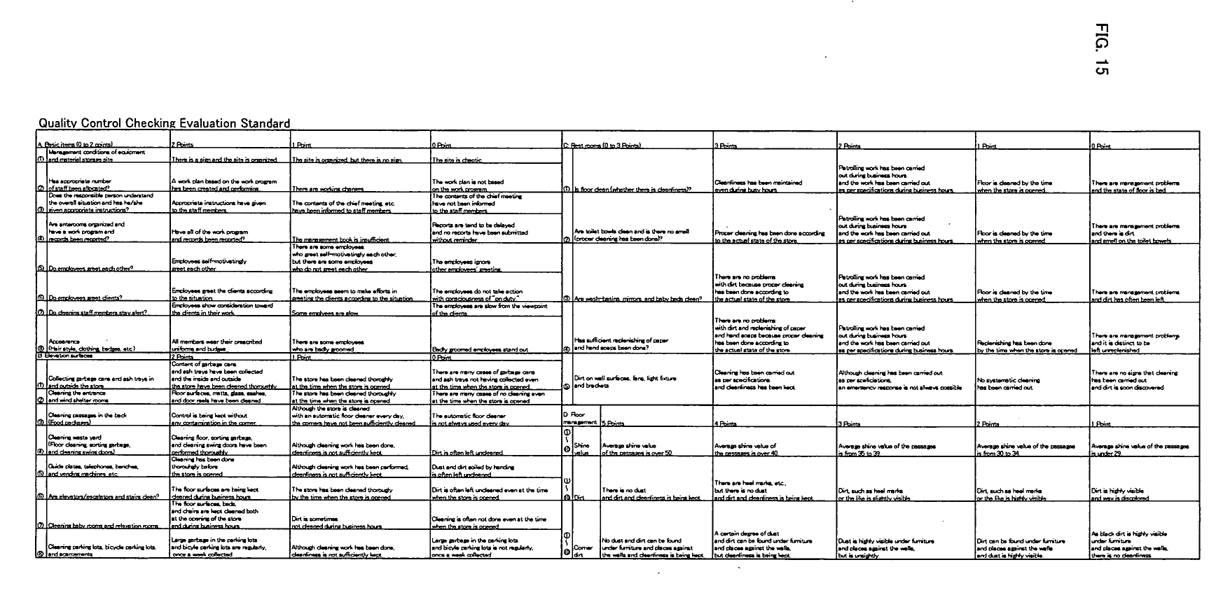

As shown in FIG. 15, the quality control checking evaluation standards stored in the evaluation standards storing means 102 list evaluation objects on items “A. Basic Items” to “D. Floor management” and describe evaluation levels corresponding to a score for each evaluation object. For instance, in terms of evaluation objects of “Management conditions of equipment and material storage site” in “A. Basic items”, “There is a sign and the site is organized” corresponding to 2 points is described, “The site is organized, but there is no sign” corresponding to 1 point is described, and “The site is chaotic” corresponding to 0 point is described. Such quality control checking evaluation standards are created based on each client's specifications for each client or each cleaning site.

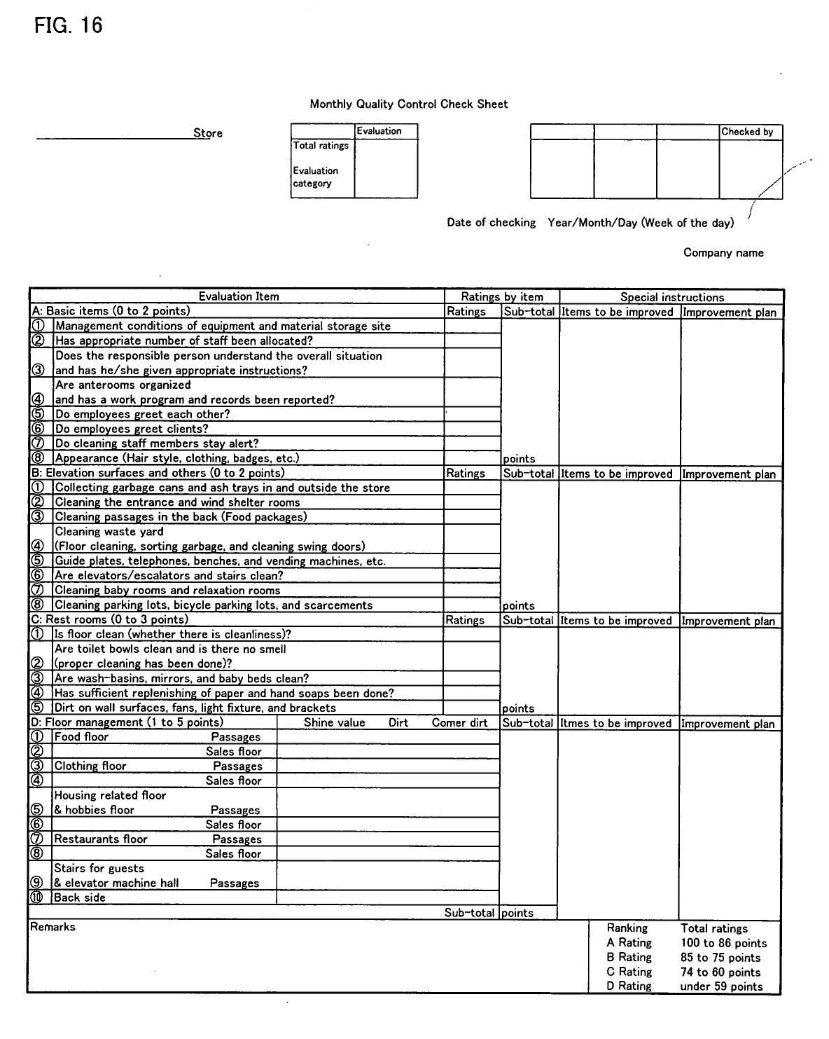

As shown in FIG. 16, the same items as those of the evaluation standards are described in the check sheet stored in the check sheet storing means 104 and a column in which a score for each item is described is respectively provided. With reference to “D. Floor management,” columns to describe the score for shine value, dirt, and corner dirt in each site, such as passages and sales space in the food floor or the like are provided.

The evaluation entering means 106 is configured so as to enter the total points after calculation, as well as to enter the score in the quality control check sheet stored in the check sheet storing means 104 based on the evaluation standards stored in the evaluation standards storing means 102. The client can look at the quality control check sheet in which scores are entered by outputting the quality control check sheet.

In response to a request from the client, the evaluation standards rewriting means 108 can rewrite the evaluation standards stored in the evaluation standards storing means 102. The procedure rewriting means 110 can rewrite the contents of work procedures allocated to the module sheets so as to assure constant quality of cleaning in compliance with the client's request. Similarly, the shift table re-creating means 112 is configured so as to re-create the shift table created so that constant quality can be assured in compliance with the client's request.

The client and the cleaner practice quality control of cleaning work in cleaning sites based on the quality control checking evaluation standards shown in FIG. 15 when necessary after the cleaner makes an estimate of the cleaning work by the allocation of the work procedures to the module sheets and then carries out the cleaning work when using the cleaning work estimating system 10 having the estimate evaluating means 100. Specifically, evaluation results are selected by item in the quality control checking evaluation standards. This selection is made by clicking or the like. A point to correspond to the evaluation results is entered in a column corresponding to the quality control check sheet shown in FIG. 16 when selecting the evaluation results. For one thing, in “Management conditions of equipment and material storage site” of “A: Basic Items”, the corresponding point is 2 points when selecting “There is a sign and the site is organized”, so that “2” is entered in the column corresponding to “Ratings by item” in the quality control check sheet. The corresponding point is 3 points when selecting “Cleaning has been carried out as per specifications and cleanliness has been kept” in “Dirt on wall surfaces, fans, light fixture, and brackets” of “C: Rest rooms”, so that “3”, is entered in the column corresponding to “Ratings by item” in the quality control check sheet.

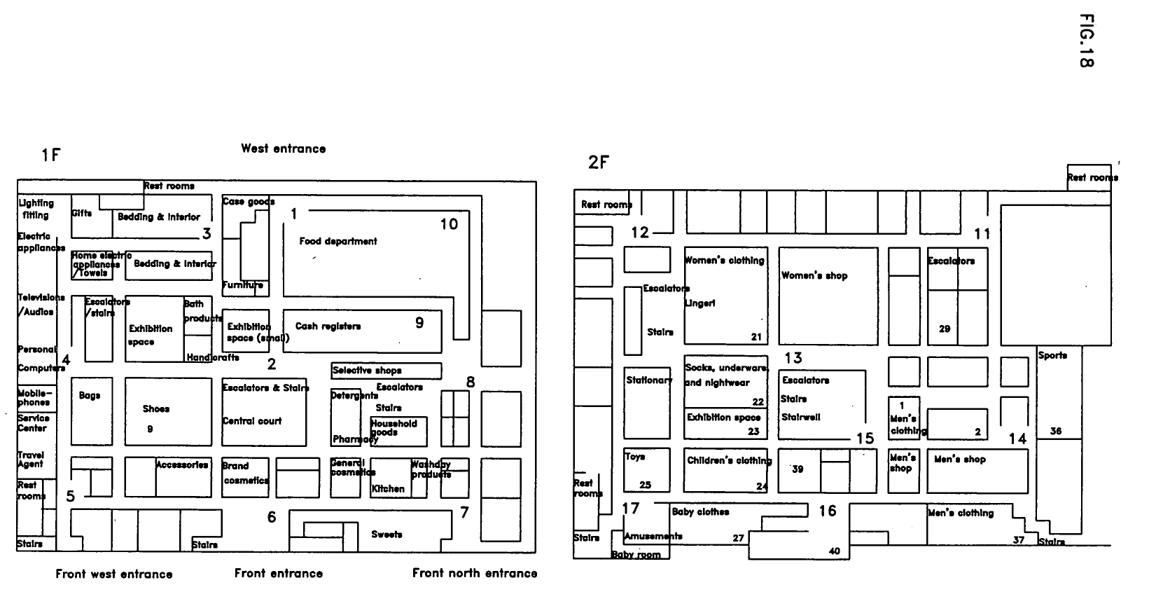

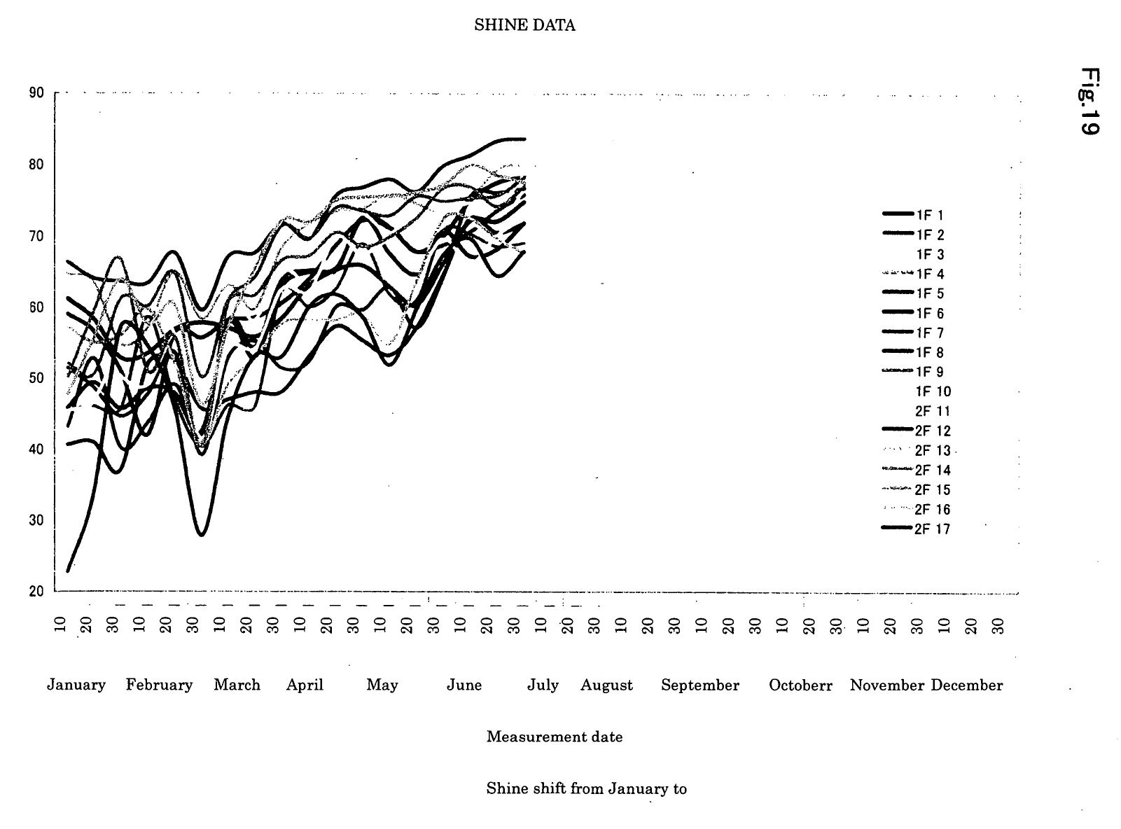

With reference to “shine value” in “D. Floor management,” evaluation results are selected based on the results obtained by a measurement made using a shine value measuring device. An example of a lay-out for showing shine measurement points is shown in FIG. 18 and measurement results of each measurement point are shown in FIG. 19.

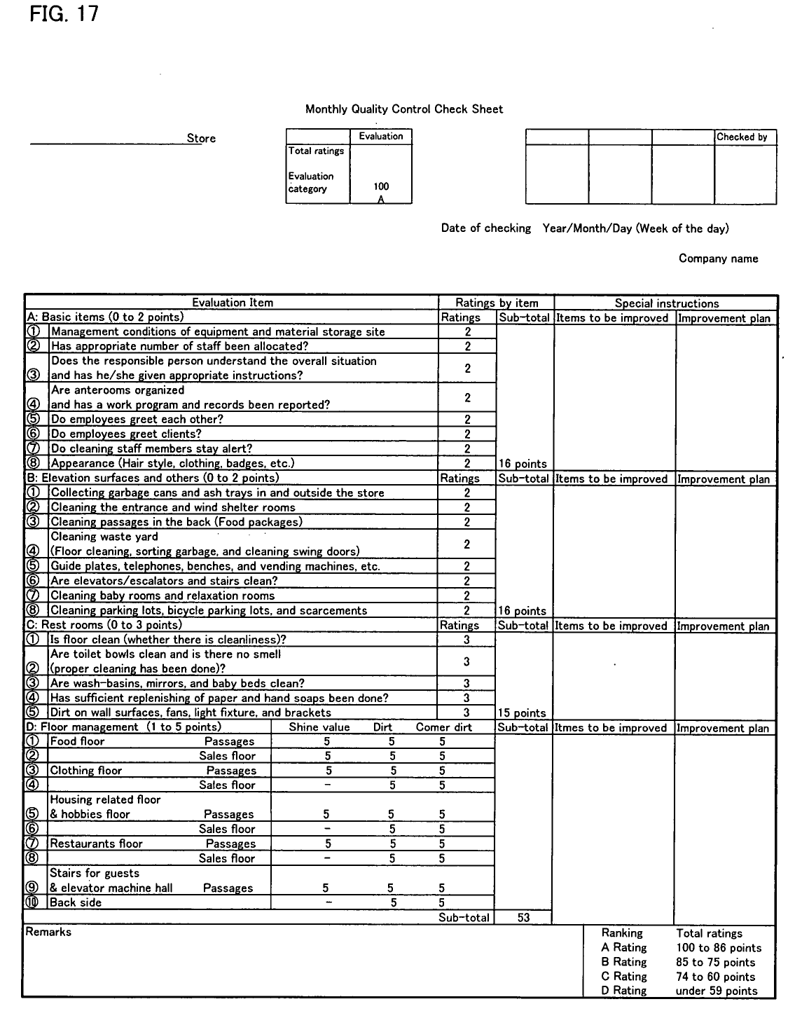

As shown in FIG. 17, evaluation results are thus entered in the quality control check sheet. The sub-total of ratings is calculated and is also entered in the quality control check sheet. Moreover, rank ratings from “A Rating” through “D Rating” corresponding to the total ratings can be confirmed. The cleaner and client study the validity of the estimated amount of the cleaning work while looking at the quality control check sheet. For instance, a study as to whether the estimated amount is too high regardless of rank ratings being C Rating or the like is carried out. The quality control checking evaluation standards are rewritten by the evaluation standards rewriting means 108 based on such study results and then the contents of the work procedures allocated to the module sheets are rewritten by the procedure rewriting means 110 to re-create the created shift table by the shift table re-creating means 112. In other words, evaluation standards are altered according to the study results and the work program is modified according to the study results.

With reference to alteration of the evaluation standards, for instance, the quality control checking evaluation standards are such altered that the shine value over 50 is set as 5 points and the shine value over 60 is set as 5 points when trying to improve the level of shine value. Further, when “A. Basic items” is more emphasized and “B. Elevation surfaces and others” is less emphasized in the total ratings, for instance, the setting, in which 2 points of score, which is the highest score for “A. Basic items”, 2 points of score, which is the highest score for “Elevation surfaces and others” is changed to the setting in which the highest score for “A. Basic item” is 3 points and the highest score for “B. Elevation surfaces and others” is 1 point. At this time, the evaluation entering means 106 enters evaluation in the check sheet based on the rewritten quality checking evaluation standards.

To modify the work program, for instance, the work procedures to be allocated to the module sheets are added so that the score can be raised. In addition, the contents of the shift table are changed so as to decrease the estimated amount.

In this way, the evaluation standards and the work program are easily reviewed in compliance with the client's request. Thus, it is possible to improve quality as well as to assure quality of the cleaning work that has been estimated.

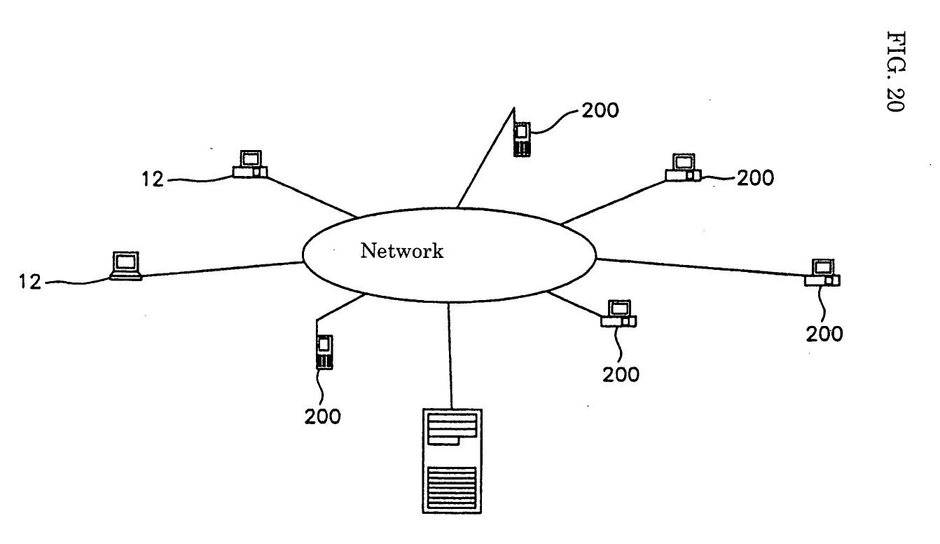

Next, it is to be understood that the estimate evaluating means 100 is not limited to be arranged in the PC 12 of the cleaner, but may be arranged in customer terminals 200 shown in FIG. 20. In this case, the client himself outputs a check sheet from the customer terminals 200 to evaluate the estimated amount.

Having such estimate evaluating means 100 makes it possible to find whether there are any problems with specifications, quality, work program, (overall work program), and education program accompanied by the work modules (productivity, level of proficiency, and morale) on the calculated sum or the existing contract sum in addition to display quality standards of the cleaning work. Further, the contract sum can be easily altered because of easy changes of the work program caused by changes, addition, deletion of the work modules.

While preferred embodiments of the present invention have thus been described based on the drawings, the present invention is not limited to the drawings.

For instance, it is to be understood that the cleaning work estimating system of the present invention is not limited to be arranged in a PC, but may be arranged in other kind of computers, such as servers or the like.

The technical scope of the present invention includes embodiments, in which various changes, modifications, and variations may be made on the basis of knowledge of those skilled in the art without departing from the scope of the invention. In addition, any of specific items of the invention may be practiced in a form of to be replaced by other technology within the scope of identical function and effects.

### INDUSTRIAL APPLICABILITY

According to the cleaning work estimating system, the cleaning work estimating method, and the cleaning work estimating program of the present invention, a cleaning work procedure can be automatically determined to be outputted according to the surface area to be cleaned or the like. Therefore, the present invention can be widely utilized for instructions given to workers in work procedure.

There have thus been shown and described a novel cleaning work estimating system, a novel cleaning work estimating method, and a novel cleaning work estimating program, which fulfill all the objects and advantages sought therefor. Many changes, modifications, variations, combinations and other uses and applications of the subject invention will, however, become apparent to those skilled in the art after considering this specification and the accompanying drawings which disclose the preferred embodiments thereof. All such changes, modifications, variations and other uses and applications which do not depart from the spirit or scope of the invention are deemed to be covered by the invention, which is to be limited only by the claims which follow.

1. A cleaning work estimating system for creating a work program for cleaning work using a computer, the system being composed of the computer, wherein the computer comprises:
area type storing means for storing the area type for each area of a floor;
surface area storing means for storing the surface area for each area;
degree of contamination storing means for storing the degree of contamination for each area;
degree of cleaning finish storing means for storing the degree of cleaning finish for each area;
work procedure selecting means for sequentially selecting work procedure for each area according to the area type, the surface area, the degree of contamination, and the degree of cleaning finish;
module sheet creating means for creating a module sheet by aligning work procedures for each area type in a time line fashion and sectioning at regular time intervals to allocate the work procedures at regular time intervals;
means for storing cost data for each regular time interval;
means for creating a database comprising a plurality of module sheets containing the work procedures and the cost data for each regular time interval;
means for storing a shift table format sectioned at regular time intervals and worker;
shift table creating means for creating a shift table by allocating each work procedure for each regular time interval contained in the database to the shift table format in a time line fashion; and
work cost estimating means for estimating work costs by summing up the cost data contained in the database.

2-4. (canceled)

5. The system according to claim 1, further comprising estimate evaluating means for evaluating an estimate for cleaning work, wherein the estimate evaluating means comprises: evaluation standards storing means for storing quality control checking evaluation standards; check sheet storing means for storing a quality control check sheet; and evaluation entering means for entering evaluation in the check sheet based on the quality control checking standards.

6. The system according to claim 5, wherein the estimate evaluating means comprises evaluation standards rewriting means for rewriting evaluation items and the quality control checking evaluation standards.

7. The system according to claim 6, wherein the evaluation entering means enters evaluation in the check sheet based on the rewritten quality control checking evaluation standards.

8. The system according to claim 5, wherein the estimate evaluating means further comprises procedure rewriting means for rewriting the contents of the work procedure allocated to the module sheet.

9. The system according to claim 1, further comprising estimate evaluating means for estimating an estimate for cleaning work, wherein the estimate evaluating means comprises: evaluation standards storing means for storing the quality control checking evaluation standards; check sheet storing means for storing the quality control check sheet; evaluation entering means for entering evaluation in the check sheet based on the quality control checking evaluation standards; and shift table re-creating means for re-creating the shift table created.

10. A cleaning work estimating method for creating a work program for cleaning work using a computer,
wherein the area type storing means in the computer comprises the step of storing the area type for each area of a floor,
wherein the surface area storing means in the computer comprises the step of storing the surface area for each area,
wherein the degree of contamination storing means in the computer comprises the step of storing the degree of contamination for each area,
wherein the degree of cleaning finish storing means in the computer comprises the step of storing the degree of cleaning finish for each area,
wherein the work procedure selecting means in the computer comprises the step of sequentially selecting the work procedure for each area according to the area type, the surface area and the degree of contamination,
wherein the module sheet creating means in the computer comprises the steps of:
creating a module sheet by aligning work procedures for each area type in a time line fashion and sectioning at regular time intervals to allocate the work procedures at regular time intervals;
wherein the computer comprises the steps of storing cost data for each regular time interval,
creating a database comprising a plurality of module sheets containing the work procedures and the cost data for each regular time interval,
and storing a shift table format sectioned at regular time intervals and worker,
wherein shift table creating means in the computer comprises the step of creating a shift table by allocating each work procedure for each regular time interval contained in the database to the shift table format in a time line fashion, and
wherein work cost estimating means in the computer comprises the step of estimating work costs by summing up the cost data contained in the database.

11-12. (canceled)

13. A cleaning work estimating program for creating a work program for cleaning work using a computer,
wherein the computer functions as the area type storing means for storing the area type for each area of a floor plan, the surface area storing means for storing the surface area for each area, the degree of contamination storing means for storing the degree of contamination for each area, the degree of cleaning finish storing means for storing the degree of cleaning finish for each area, the work procedure selecting means for sequentially selecting work procedure for each area according to the area type, the surface area and the degree of contamination,
the module sheet creating means for creating a module sheet by aligning work procedures for each area type in a time line fashion and sectioning at regular time intervals to allocate the work procedures at regular time intervals,
means for storing cost data for each regular time interval, means for creating a database comprising a plurality of module sheets containing the work procedures and the cost data for each regular time interval,
means for storing a shift table format sectioned at regular time intervals and worker, shift table creating means for creating a shift table by allocating each work procedure for each regular time interval contained in the database to the shift table format in a time line fashion, and work cost estimating means for estimating work costs by summing up the cost data contained in the database.

14-15. (canceled)
